(19) United States
(12) Patent Application Publication
(10) Pub. No.: US 2022/0250506 A1
(43) Pub. Date: Aug. 11, 2022

(54) BATTERY THERMAL PRECONDITIONING

(71) Applicant: GM GLOBAL TECHNOLOGY OPERATIONS LLC, Detroit, MI (US)

(72) Inventors: Claudia Goldman-Shenhar, Mevasseret Zion (IL); Nadav Baron, Herzliya (IL); Lawrence P. Ziehr, Clarkston, MI (US); Ravid Erez, Hod-Hasharon (IL); Maxim Smirnov, Herzliya (IL); Barak Hershkovitz, Herzliya (IL)

(21) Appl. No.: 17/168,425

(22) Filed: Feb. 5, 2021

(51) Int. Cl. B60L 58/26; G01C 21/34; B60L 58/27; G01C 21/36

(52) U.S. Cl. CPC B60L 58/26; G01C 21/3679; B60L 58/27; G01C 21/3469

(57) ABSTRACT

Battery thermal preconditioning includes scheduling thermal preconditioning in accordance with user presets, preferences and battery and/or vehicle conditions and profiles. Thermal preconditioning in advance of charging events may optimize charge time, battery health and range. Manual and predictive intelligence methods may be employed to attain and maintain a predetermined range of battery pack temperatures.

### INTRODUCTION

Vehicles may include a rechargeable energy storage system (RESS) including at least one battery pack which may be configured from several battery modules and a multiplicity of individual battery cells. Battery performance may be improved and battery life may be extended when charging and discharging by maintaining battery temperature within certain ranges. In addition to performance and longevity benefits of maintaining certain temperature ranges during battery charging and discharging, charge time may be reduced when performed within a certain temperature range.

### SUMMARY

In one exemplary embodiment, a method for preconditioning a battery pack in a vehicle may include executing a machine learning model providing a probability of a charging event occurring with respect to time based upon a current vehicle location and temporal information. In response to the probability of the charging event within a predetermined timeframe exceeding a predetermined threshold, a preferred charging station and a duration for a thermal conditioning event may be determined. A thermal management system may be controlled to control the battery pack to a predetermined temperature range for the duration.

In addition to one or more of the features described herein, the machine learning model may be trained with a training dataset including vehicle usage information and temporal information.

In addition to one or more of the features described herein, the vehicle usage information may include charge site visitations, battery pack range, vehicle origin and vehicle destination.

In addition to one or more of the features described herein, the training dataset may further include at least one user preference.

In addition to one or more of the features described herein, the at least one user preference may include at least one of charging time and battery pack range.

In addition to one or more of the features described herein, executing the machine learning model may occur off the vehicle.

In addition to one or more of the features described herein, training the machine learning model may occur off the vehicle.

In addition to one or more of the features described herein, controlling the thermal management system may include heating the battery pack.

In addition to one or more of the features described herein, controlling the thermal management system may include cooling the battery pack.

In addition to one or more of the features described herein, the training dataset may further include a user schedule.

In another exemplary embodiment, a system for preconditioning a battery pack in a vehicle may include a thermal management system including a battery pack heater powered by the battery pack, a processor and a memory containing a computer program which when executed by the processor causes a machine learning model to predict a charging event occurring with respect to time based upon a current vehicle location and temporal information, determine a preferred charging station, determine a duration for a thermal conditioning event, and control the thermal management system to control the battery pack to a predetermined temperature range for the duration.

In addition to one or more of the features described herein, the computer program may include a machine learning model.

In addition to one or more of the features described herein, the machine learning model may include a probability model and predicting the charging event occurring with respect to time based upon a current vehicle location and temporal information may include providing a probability of the charging event occurring within a predetermined time frame based upon a current vehicle location and temporal information.

In addition to one or more of the features described herein, the machine learning model may be trained off the vehicle.

In addition to one or more of the features described herein, the probability model may be trained off the vehicle with a training dataset that may include vehicle usage information and temporal information.

In addition to one or more of the features described herein, the vehicle usage information may include charge site visitations, battery pack range, vehicle origin and vehicle destination.

In addition to one or more of the features described herein, the training dataset may further include at least one user preference.

In addition to one or more of the features described herein, the at least one user preference may include at least one of charging time and battery pack range.

In yet another exemplary embodiment, a battery electric vehicle may include a controller, a rechargeable battery pack, and a battery pack heater powered by the battery pack. The controller may be configured to receive at least one user preference, vehicle usage information including a current vehicle location and temporal information. The controller may be configured to provide a probability of a charging event occurring within a predetermined time frame based upon the current vehicle location and temporal information. And, in response to the probability of the charging event exceeding a predetermined threshold, the controller may be configured to determine a preferred charging station for the charging event, determine a duration for powering the battery pack heater by the battery pack sufficient to heat the battery pack to a predetermined range of temperature within the predetermined time frame, and power the battery pack heater with the battery pack for the duration.

In addition to one or more of the features described herein, the controller may be further configured to receive a user schedule, and the probability of the charging event occurring within a predetermined time frame may be further based upon the user schedule.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 illustrates exemplary vehicle hardware and a communications environment related to the presently disclosed methods and apparatus; and

FIG. 2 illustrates a battery pack thermal preconditioning scheduler, in accordance with the present disclosure.

### DETAILED DESCRIPTION

The following description is merely exemplary in nature and is not intended to limit the present disclosure, its application or uses. Throughout the drawings, corresponding reference numerals indicate like or corresponding parts and features. As used herein, vehicle control module, control module, module, control, controller, control unit, electronic control unit, similar terms may include one or various combinations of one or more of Application Specific Integrated Circuit(s) (ASIC), electronic circuit(s), processor/central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, in vehicle networks, in-plant and service-related networks, and other networks remote from or off-board the vehicle. Functions of control modules as set forth in this disclosure may be performed in a distributed control architecture among several networked control modules. Software, firmware, programs, instructions, routines, code, algorithms and similar terms mean any controller executable instruction sets including calibrations, data structures, and look-up tables. A vehicle control module (VCM) may have a set of control routines executed to provide described functions. Routines may be executed, such as by a processor, and are operable to monitor inputs from sensing devices and other networked control modules and execute control and diagnostic routines to control operation of actuators. Routines may be executed at regular intervals during ongoing vehicle operation or during periods of vehicle inactivity. Alternatively, routines may be executed in response to occurrence of an event, software calls, or on demand via user interface inputs or requests.

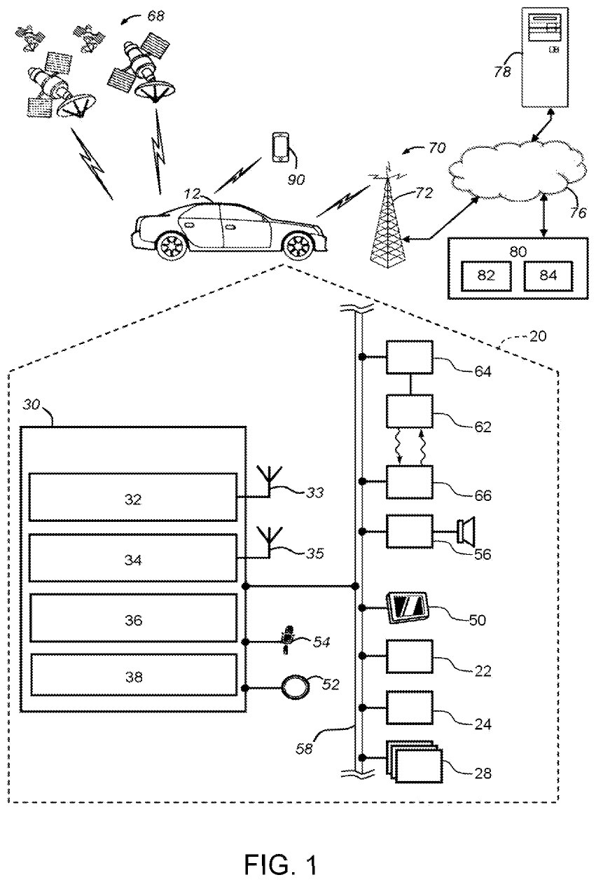

With reference to FIG. 1, exemplary vehicle hardware and a communications environment related to the presently disclosed methods and apparatus are illustrated. A vehicle 12 is depicted as a passenger car, but it should be appreciated that any other vehicle including motorcycles, trucks, sports utility vehicles (SUVs), recreational vehicles (RVs), marine vessels, aircraft, etc., may also be used. Some of the vehicle hardware 20 is shown generally in FIG. 1 and may include a variety of networked (VCMs) such as a global navigation satellite system (GNSS) receiver 22, a body control module (BCM) 24, a wireless communications device 30, vehicle-user interfaces 50-56, an RESS including a battery pack 62, a battery management system including a battery pack control module (BPCM) 64, a battery pack thermal management system (TMS) 66, and other VCMs 28 performing functions related to various vehicle systems (e.g., chassis, steering, braking, communications, navigation, infotainment, energy management, propulsion, etc.). Some or all of the different vehicle hardware may be coupled for communication with each other via one or more communication bus 58. Communications bus 58 may provide the vehicle electronics with network connections using one or more network protocols. Examples of suitable network connections include a controller area network (CAN), a media oriented system transfer (MOST), a local interconnection network (LIN), a local area network (LAN), and other appropriate network connections such as Ethernet or others that conform with known ISO, SAE and IEEE standards and specifications, to name but a few. In other embodiments, each of the VCMs may communicate using a wireless network and may include suitable hardware, such as short-range wireless communications (SRWC) circuitry.

In the illustrated embodiment, the vehicle 12 is a battery electric vehicle (BEV) that may use the RESS for propulsion as well as other vehicle electrical loads. The BPCM 64 may be integrated with a propulsion system control module for managing BEV powertrain functions, including controlling wheel torque and battery pack charging. In other embodiments, the vehicle 12 may be a hybrid (e.g., a plug-in hybrid electric vehicle (PHEV)) or an internal combustion engine (ICE) vehicle. The battery pack 62 for BEVs and PHEVs may include at least one high voltage battery module, for example at about 400 volts nominal terminal voltage. The battery pack 62 may include multiple high voltage battery modules. Multiple high voltage battery modules may be configured in parallel during vehicle propulsion periods and in series during recharging periods. High voltage battery modules primarily service vehicle propulsion system components such as traction motors. Certain high-power vehicle accessory loads, for example electrically driven air conditioning compressors or vehicle cabin heaters, may also be serviced by high voltage battery modules. BEVs and PHEVs may include at least one low voltage battery module, for example about 12 volts nominal terminal voltage. A low voltage battery module may service vehicle loads requiring voltages substantially below the voltage of the high voltage battery modules. Such vehicle loads may include, for example, engine starting, vehicle lighting, infotainment, accessory motors, resistive or PTC heating loads such as glass defroster/deicer or seat heaters, and control electronics including various VCMs. ICE vehicles may only include a low voltage battery module to service low voltage vehicle loads. The RESS may include a battery disconnect unit (BDU) (not illustrated) to effect various reconfigurations of and among multiple battery modules of a battery pack 62. For example, a BDU may selectively configure high voltage battery modules of a battery pack 62 at one overall terminal voltage (e.g., 400 volts) for propulsion and at another overall terminal voltage (e.g., 800 volts) for off-board DC fast charging (DCFC). A BDU may be integrated into one or more controllable units, or physically and functionally distributed variously within components or subsystems, for example within battery pack 62 containment packaging.

The BPCM 64 may monitor various metrics within the battery pack including, for example, battery pack 62 (including battery modules and battery cells) voltage, current and temperature. The BPCM 64 may determine from such metrics state of charge (SOC), state of health (SOH), and temperature of the battery pack 62 (including battery modules and battery cells). SOC may be used to determine battery pack range in accordance with known algorithms and models considering historical usage, driving patterns, planned trip routes, and other metrics.

The battery pack TMS 66 may include bi-directional heat transfers into and out of the battery pack 62. The battery pack TMS 66 may include, for example, a cooling plate for dissipating heat from the battery pack and positive thermal coefficient (PTC) heating devices, both preferably integrated within the battery pack 62 beneath or between battery modules. Other heating technologies including resistive heating may be employed. The cooling plate may include fluid circulated therethrough and through an external cooling circuit. The cooling circuit may include an electrically driven refrigerant compressor. The battery pack 62 is the source of electrical energy for heating and cooling the battery pack, both of which will result in reduction of battery pack 62 charge and SOC reduction. The battery pack TMS 66 may include an integrated controller or one or more VCMs, including BCM 24 or BPCM 64 to implement controls related to the battery pack thermal management. For example, the BPCM 64 may control electrical heating of the battery pack by controlling the conductive states of the PTC heating devices. The BPCM 64 may control battery pack cooling by controlling the state of cooling circuit fluid flow. It is appreciated that target temperatures for the battery pack may be achieved by way of the controllable battery pack heating and cooling apparatus of the battery pack TMS. In one embodiment, prior to a battery pack charging event, the battery pack is preconditioned to a predetermined target temperature.

The VCMs may receive input from one or more sensors and shared bus data, and use the inputs to perform diagnostic, monitoring, control, reporting, and/or other functions related to various vehicle systems. Each of the VCMs 28 is connected by communications bus 58 to the other VCMs, as well as to the wireless communications device 30. One or more VCMs 28 may periodically or occasionally have their software or firmware updated and, in some embodiments, such updates may be over the air (OTA) updates that are received from a computer 78 or backend facility 80 via remote network 76 and communications device 30. Remote network 76 is understood to be off the vehicle 12. As is appreciated by those skilled in the art, the above-mentioned VCMs are only examples of some of the modules that may be used in vehicle 12.

Wireless communications device 30 is capable of communicating data via short-range wireless communications (SRWC) and/or via cellular network communications through use of a cellular chipset 34, as depicted in the illustrated embodiment. In one embodiment, the wireless communications device 30 is a VCM that may be used to carry out at least part of the methods disclosed herein. In the illustrated embodiment, wireless communications device 30 includes an SRWC circuit 32, cellular chipset 34, a processor 36, memory 38, and antennas 33 and 35. In one embodiment, wireless communications device 30 may be a standalone module or, in other embodiments, wireless communications device 30 may be incorporated or included as a part of one or more other VCMs, such as a center stack module (CSM), a body control module BCM 24, an infotainment module, a head unit, and/or a gateway module. The wireless communications device 30 may be integrated with the GNSS receiver 22 so that, for example, the GNSS receiver 22 and the wireless communications device 30 are directly connected to one another as opposed to being connected via communications bus 58.

In some embodiments, the wireless communications device 30 may be configured to communicate wirelessly according to one or more short-range wireless communications (SRWC) protocols such as any of the Wi-Fi™, WiMAX™, Wi-Fi Direct™, other IEEE 802.11 protocols, ZigBee™, Bluetooth™, Bluetooth™ Low Energy (BLE), Ultra-wideband, or near field communication (NFC). The short-range wireless communication (SRWC) circuit 32 enables the wireless communications device 30 to transmit and receive SRWC signals. The SRWC circuit may allow the device 30 to connect to another SRWC device. Additionally, in some embodiments, the wireless communications device may contain a cellular chipset 34 thereby allowing the device to communicate via one or more cellular protocols, such as those used by a cellular carrier system 70. In such a case, the wireless communications device becomes user equipment (UE) usable in carrying out cellular communications via cellular carrier system 70.

Wireless communications device 30 may enable vehicle 12 to be in communication with one or more remote networks 76 and one or more backend facility 80 or computer 78 via packet-switched data communication. This packet-switched data communication may be carried out through use of an off-vehicle wireless access point that is connected, for example, to a wide area network via a router or modem. When used for packet-switched data communication such as TCP/IP, the communications device 30 may be configured with a static IP address or may be set up to automatically receive an assigned IP address from another device on the network such as a router or from a network address server. Packet-switched data communications may also be carried out via use of a cellular network that may be accessible by the device 30. Communications device 30 may, via cellular chipset 34, communicate data over cellular carrier system 70. In such an embodiment, radio transmissions may be used to establish a communications channel, such as a voice channel and/or a data channel, with wireless carrier system 70 so that voice and/or data transmissions may be sent and received over the channel. Data may be sent either via a data connection, such as via packet data transmission over a data channel, or via a voice channel using techniques known in the art. For combined services that involve both voice communication and data communication, the system may utilize a single call over a voice channel and switch as needed between voice and data transmission over the voice channel, all of which may be done using techniques known to those skilled in the art.

Processor 36 may be any type of device capable of processing electronic instructions including microprocessors, microcontrollers, host processors, controllers, vehicle communication processors, ASICs, etc. It may be a dedicated processor used only for communications device 30 or may be shared with other vehicle systems. Processor 36 may execute various types of digitally-stored instructions, such as software or firmware programs stored in memory 38, which enable the device 30 to provide a wide variety of services. For instance, processor 36 may execute programs or process data to carry out at least a part of the methods discussed herein. Memory 38 may be a temporary powered memory, any non-transitory computer readable medium, or other type of memory. For example, the memory may be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives. Similar components to those previously described (processor 36, memory 38, SRWC circuit 32 and cellular chipset 34) may be included in other VCMs, including BCM 24 and BPCM 64.

The wireless communications device 30 is connected to the bus 58, and may receive data from one or more onboard vehicle sensors, shared bus data, and user inputs. The vehicle may send this data (or other data derived from or based on this data) to other devices or networks, including remote networks 76 and one or more backend facility 80 or computer 78. And, in another embodiment, the wireless communications device 30 may be incorporated with or connected to a navigation system that includes geographical map information including geographical roadway map data. The navigation system may be communicatively coupled to the GNSS receiver 22 (either directly or via communications bus 58) and may include an on-board geographical map database that stores local geographical map information. This local geographical map information may be provisioned in the vehicle and/or downloaded via a remote connection to a geographical map database/server, such as computer 78 and/or backend facility 80 (including servers 82 and databases 84). The on-board geographical map database may store geographical map information corresponding to a location or region of the vehicle so as to not include a large amount of data. Moreover, as the vehicle 12 enters different locations or regions, the vehicle may inform the vehicle backend services facility 80 of the vehicle's location (e.g., obtained via use of GNSS receiver 22) and, in response to receiving the vehicle's new location, the servers 82 may query databases 84 for the corresponding geographical map information, which may then be sent to the vehicle 12.

GNSS receiver 22 receives radio signals from a constellation of GNSS satellites. As known in the art, GNSS receiver 22 may be configured for operation within a given geopolitical region (e.g., country). The GNSS receiver 22 may be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 68. And, in another example, GNSS receiver 22 may be a BDS receiver that receives a plurality of BDS signals from a constellation of BDS satellites 68. In any implementation, GNSS receiver 22 may include at least one processor and memory, including a non-transitory computer readable memory storing instructions (software) that are accessible by the processor for carrying out the processing performed by the GNSS receiver 22.

GNSS receiver 22 may be used to provide navigation and other position-related services to the vehicle operator and systems. Navigation information may be presented on the display 50 (or other display within the vehicle such as an application program on mobile device 90 or head-up display) or may be presented verbally such as is done when supplying turn-by-turn navigation. The navigation services may be provided using a dedicated in vehicle navigation module (which may be part of GNSS receiver 22 and/or incorporated as a part of wireless communications device 30 or other VCM), or some or all navigation services may be done via the wireless communications device 30 (or other telematics-enabled device) installed in the vehicle, wherein the position or location information is sent to a remote location for purposes of providing the vehicle with navigation maps, map annotations and geographic information system (GIS) data (points of interest, restaurants, etc.), route calculations, and the like. These remote locations may be the vehicle backend services facility 80 or other remote computer system, such as computer 78. Also, new updated map data, such as that geographical roadway map data stored on databases 84, may be downloaded to the GNSS receiver 22 (or other VCM) from the backend facility 80 via vehicle communications device 30.

BCM 24 may be used to control various other VCMs of the vehicle, as well as obtain information concerning other VCMs, including their present state or status, and sensor information. BCM 24 is shown in the exemplary embodiment of FIG. 1 as being electrically coupled to communication bus 58. In some embodiments, the BCM 24 may be integrated with or as part of a center stack module (CSM) and/or integrated with the wireless communications device 30. BCM 24 may include a processor and memory, which may be similar to processor 36 and memory 38 of wireless communications device 30, as disclosed herein. BCM 24 may communicate with wireless device 30, an audio system 56, BPCM 64, TMS 66, and other VCMs 28. BCM 24 may include a processor and memory accessible by the processor. Suitable memory may include non-transitory computer-readable memory that includes various forms of non-volatile RAM and ROM. Software stored in the memory and executable by the processor enables the BCM to direct one or more vehicle functions or operations including, for example, controlling central locking, heating/ventilation/air conditioning (HVAC) functions, power mirrors, and/or controlling various other vehicle modules. For example, the BCM 24 may send signals to other VCMs, such as a request to perform a particular operation or a request for sensor information and, in response, the sensor may then send back the requested information. And, the BCM 24 may receive data from VCMs, battery pack 62 information from BPCM 64, battery pack thermal management information from TMS 66, and various other vehicle component and system information from other VCMs. The data may be sent to the wireless communications device 30 automatically upon receiving a request from the device/computer, automatically upon certain conditions being met, or periodically (e.g., at set time intervals). As discussed in more detail below, the BCM 24 may be configured with one or more triggers that, when a condition is satisfied, the BCM performs some operation, such as sending sensor information to the wireless communications device 30 (or to another device or entity, such as backend facility 80). In this way, the BCM 24 may filter information based on predetermined or predefined triggers and pass the filtered information on to other VCMs, including the wireless communications device 30.

The vehicle 12 includes a plurality of vehicle sensors related to various vehicle systems, components and environment. Also, certain vehicle-user interfaces 50-56 may be utilized to interface with a user. Generally, the sensors may obtain information pertaining to either the operating state of the vehicle (the “vehicle operating state”) or the environment of the vehicle (the “vehicle environmental state”). The sensor information may be sent, for example, to BCM 24, BPCM 64, TMS 66, the vehicle communications device 30, and other VCMs 28, via communications bus 58. Also, in some embodiments, the sensor data may be sent with metadata, which may include data identifying the sensor (or type of sensor) that captured the sensor data, a timestamp (or other time indicator), and/or other data that pertains to the sensor data, but that does not make up the sensor data itself. The “vehicle operating state” refers to a state of the vehicle concerning the operation of the vehicle, which may include the operation of the propulsion system. Additionally, the vehicle operating state may include the vehicle state concerning mechanical operations of the vehicle or electrical states of the vehicle. The “vehicle environmental state” refers to a vehicle state concerning the interior of the cabin and the nearby, exterior area surrounding the vehicle. The vehicle environmental state includes behavior of a driver, operator, or passenger, as well as traffic conditions, roadway conditions and features, and statuses of areas nearby the vehicle.

Vehicle-user interfaces 50-56 may provide vehicle occupants with a means of receiving and providing information, including visual display 50, pushbutton(s) 52, microphone 54, and audio system 56. As used herein, the term “vehicle-user interface” broadly includes any suitable device, including both hardware and software components, located on the vehicle and enables a vehicle user to communicate with or through a component of the vehicle. Vehicle-user interfaces 50-56 are also onboard vehicle sensors that may receive input from a user or other sensory information. The pushbutton(s) 52 allow manual user input into the communications device 30 to provide other data, response, or control input. Audio system 56 provides audio output to a vehicle occupant and may be a dedicated, standalone system or part of the primary vehicle audio system. According to the particular embodiment shown here, audio system 56 is operatively coupled to both communications bus 58 and an entertainment bus (not shown) and may provide AM, FM and satellite radio, CD, DVD and other multimedia functionality. This functionality may be provided in conjunction with or independent of an infotainment module. Microphone 54 provides audio input to the wireless communications device 30 to enable the driver or other occupant to provide voice commands and/or carry out hands-free calling via the wireless carrier system 70. For this purpose, it may be connected to an on-board automated voice processing unit utilizing human-machine interface (HMI) technology (e.g., dialogue manager) known in the art. Visual display 50 is preferably a graphics display and may be used to provide a multitude of input and output functions. Visual display 50 may be a touch screen on the instrument panel, or a head up display, for example. Various other vehicle-user interfaces may also be utilized, such as the mobile device 90, as the interfaces of FIG. 1 are exemplary and not limiting.

A user of the vehicle 12 may use one or more vehicle-user interfaces 50-56 to input information such as preferences and settings for various vehicle system customizations. In one embodiment, the user may operate one or more vehicle-user interfaces 50-56, which may then deliver inputted information, for example, to BCM 24, BPCM 64, TMS 66, the vehicle communications device 30, and other VCMs 28. The wireless communications device 30, for example, may then send this information to the backend facility 80 using the cellular chipset 34 or other communications means. In one embodiment, the user may use the visual display 50 to enter a desired destination to which the user would like to travel to, for example a charging station. The destination may include a street address or may include a point of interest or other geographical indicator. The destination may be represented in many forms, such as through geographical coordinates or textual data that is embodied in a vehicle navigational request message. A departure location may also be specified in the vehicle navigational request message. The departure location may be specified by the user via the vehicle-user interfaces, or may be determined or preset to be the vehicle's current location, which may be determined using GNSS receiver 22 or through use of other location services. This vehicle navigational request message may then be sent using the wireless communications device 30 (e.g., through SRWC circuitry 32 or cellular chipset 34) to the backend facility 80 or other remote computing system (e.g., computer 78), which may then provide navigational information to the vehicle 12. This navigational information may be displayed on the visual display 50 or may be presented via use of other vehicle-user interfaces that may be used for presenting output. The navigational information may provide one or more route segments as well as geographical roadway map data.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the remote network 76 or to connect the wireless carrier system with user equipment (UEs, e.g., which may include telematics equipment in vehicle 12). Carrier system 70 may implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication may be used to provide uni-directional or bi-directional communication with the vehicle. This may be done using one or more communication satellites (not shown) and an uplink transmitting station (not shown). Uni-directional communication may be, for example, satellite radio services, wherein programming content (news, music, etc.) is received by the uplink transmitting station, packaged for upload, and then sent to the satellite, which broadcasts the programming to subscribers. Bi-directional communication may be, for example, satellite telephony services using the one or more communication satellites to relay telephone communications between the vehicle 12 and the uplink transmitting station. If used, this satellite tele phony may be utilized either in addition to or in lieu of wireless carrier system 70.

Remote network 76 may be a conventional land-based telecommunications network that connects wireless carrier system 70 to vehicle backend services facility 80. For example, remote network 76 may include a public switched telephone network (PSTN) such as that used to provide hardwired telephony, packet-switched data communications, and the Internet infrastructure. One or more segments of remote network 76 could be implemented through the use of a standard wired network, a fiber or other optical network, a cable network, power lines, other wireless networks such as wireless local area networks (WLANs), or networks providing broadband wireless access (BWA), or any combination thereof.

Computer 78 includes at least one processor and memory and may be accessible via a private or public network such as the Internet. In one embodiment, computer 78 may be used for one or more purposes, such as for providing navigational services to a plurality of vehicles and other electronic network computing devices, including vehicle 12 and personal mobile device 90. Computer 78 may be, for example: a service center computer where diagnostic information and other vehicle data may be uploaded from the vehicle for remote data processing services related to the vehicle 12 as further described herein; a client computer used by the vehicle owner or other subscriber for such purposes as accessing, receiving and provisioning vehicle data, setting up or configuring subscriber preferences, updating and maintaining vehicle assets including VCMs software and data including models; a car sharing server which coordinates registrations from a plurality of users who request to use a vehicle as part of a car sharing service; or a third party repository to or from which vehicle data or other is provided, whether by communicating with the vehicle 12, backend facility 80, or both. A computer 78 may also be used for providing Internet connectivity such as DNS services or as a network address server that uses DHCP or other suitable protocol to assign an IP address to vehicle 12.

Vehicle backend services facility 80 is a backend facility and is located at a physical location that is located remotely from vehicle 12. The vehicle backend services facility 80 (or “backend facility 80” for short) may be designed to provide the vehicle hardware 20 with a number of different system back-end functions through use of one or more electronic servers 82 and, in many cases, may provide navigation-related services to a plurality of vehicles. In one embodiment, the backend facility 80 provides route suggestions (or a planned route). The vehicle backend services facility 80 includes vehicle backend services servers 82 and data bases 84, which may be stored on a plurality of memory devices. Vehicle backend services facility 80 may include any or all of these various components and, preferably, each of the various components are coupled to one another via a wired or wireless local area network. Backend facility 80 may receive and transmit data via a modem connected to remote network 76. Data transmissions may also be conducted by wireless systems, such as IEEE 802.11x, GPRS, and the like. Those skilled in the art will appreciate that, although only one backend facility 80 and one computer 78 are depicted in the illustrated embodiment, numerous remote facilities 80 and/or computers 78 may be used. Moreover, a plurality of backend facilities 80 and/or computers 78 may be geographically distributed and may each coordinate information and services with one another, as those skilled in the art will appreciate.

Server 82 and computer 78 may be computers or other computing devices that include at least one processor and that include memory. The processors may be any type of device capable of processing electronic instructions including microprocessors, microcontrollers, host processors, controllers, vehicle communication processors, and ASICs. The processors may be dedicated processors used only for server 82 or computer 78 or may be shared with other systems. The at least one processor may execute various types of digitally-stored instructions, such as software or firmware, which enable the server 82 or computer 78 to provide a wide variety of services. This software may be stored in computer-readable memory and may be any suitable non transitory, computer-readable medium. For example, the memory may be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives. For network communications (e.g., intra-network communications, inter-network communications including Internet connections), the servers may include one or more network interface cards (NICs) (including wireless NICs (WNICs)) that may be used to transport data to and from the computers. These NICs may allow the one or more servers 82 or computers 78 to connect with one another, databases 84, or other networking devices, including routers, modems, and/or switches. In one particular embodiment, the NICs (including WNICs) of servers 82 or computers 78 may allow SRWC connections to be established and/or may include Ethernet (IEEE 802.3) ports to which Ethernet cables may be connected to that may provide for a data connection between two or more devices. Backend facility 80 may include a number of routers, modems, switches, or other network devices that may be used to provide networking capabilities, such as connecting with remote network 76 and/or cellular carrier system 70.

Databases 84 may be stored on a plurality of memory, such as a powered temporary memory or any suitable non-transitory, computer-readable medium. For example, the memory may be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. One or more databases at the backend facility 80 may store various information and may include geographical roadway information databases, and other vehicle information databases.

In one embodiment, the battery pack 62 may be Lithium chemistry based. It is known that low temperatures reduce Lithium battery performance which then may be more prone to damage at aggressive discharge. Similarly, it is known that higher temperature discharging may reduce cycle life or result in undesirable venting of Lithium batteries. Other undesirable effects upon the battery pack 62 may be incurred if the battery pack 62 is discharged outside of the predetermined temperature range. Other battery chemistries have similar discharge-temperature concerns and generally will have a predetermined range of temperature preferred for discharge. Moreover, battery pack 62 charging is preferably accomplished within another predetermined range of temperatures for similar reasons. As well, low battery pack 62 temperatures may significantly increase the time it takes to recharge a battery pack 62. Thus, TMS 66 may be called upon to heat the battery pack 62 if it is below the predetermined temperature range and to cool the battery pack 62 if it is above the predetermined temperature range, and to otherwise maintain the battery pack 62 within the predetermined temperature range.

In accordance with one embodiment, the TMS 66 may be used to precondition the battery pack 62 for efficient drive cycles. For example, prior to motive operation of the vehicle 12, it may be desirable that the battery pack 62 be within a predetermined temperature range for a drive cycle and the TMS 66 is used for that objective. In accordance with another embodiment, the TMS 66 is used to control the battery pack 62 temperature to a predetermined range for a battery recharge event. In one embodiment, temperature of the battery pack 62 is controlled to account for the competing objectives of battery pack 62 SOC and thus battery pack range and desired battery pack temperature at time of charge event and thus time required to charge the battery pack 62. In accordance with the present disclosure, it is generally desirable to thermally precondition the battery pack 62 in order that the vehicle 12 gets to a charging station within a predetermined temperature range for charge acceptance and in consideration of the specific drive cycle and/or user preferences. In one embodiment, the timing of a drive cycle or trip may be manually set by the user. In another embodiment, the timing of a drive cycle or trip may be predictively determined.

In accordance with the present disclosure, a thermal preconditioning of the battery pack 62 in anticipation of a charge event may be accomplished through a variety of manual or automated invocations. In a manual invocation, a user may manually request thermal preconditioning of the battery pack 62 in preparation for an incipient charge event. In an automated invocation, the user is not generally and ongoingly directly involved in requesting thermal preconditioning of the battery pack 62; rather, an automated system may be responsible for invoking thermal preconditioning of the battery pack 62 in preparation for a charge event, for example based upon predictive intelligence. Predictive intelligence may vary in complexity and scope. For example, thermal preconditioning requests may be driven by an event based model, by an anticipatory schedule based model, by a combination of such intelligent schedulers or other learning systems.

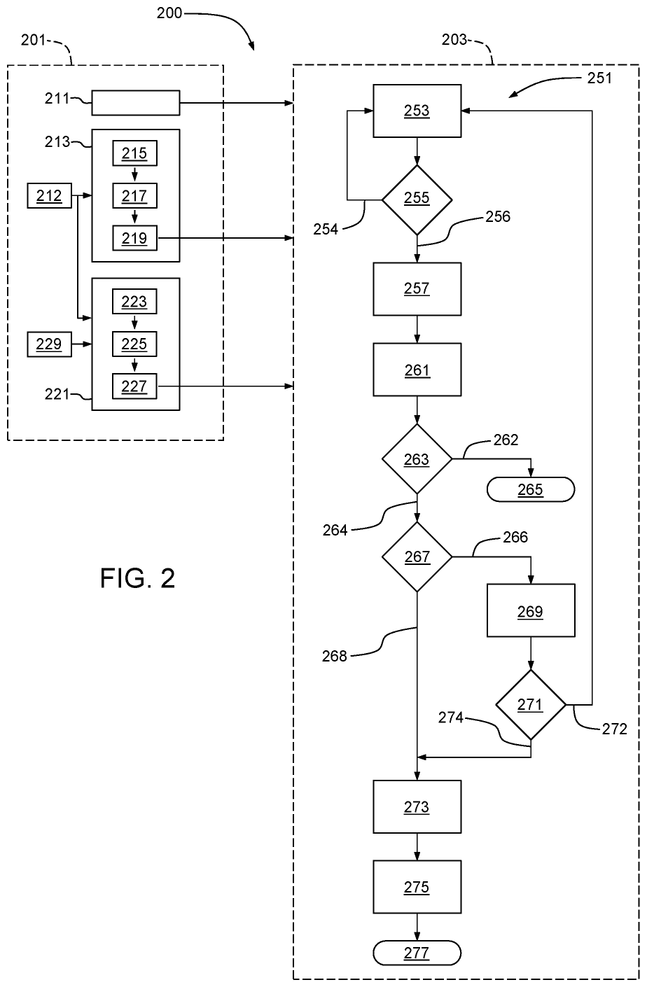

With reference to FIG. 2, a battery pack thermal preconditioning scheduler 200 is represented in a block diagram of relationships and flows among functional modules and steps. The battery pack thermal preconditioning scheduler 200 may be implemented in one or more processors on-board and off-board the vehicle 12 (FIG. 1) as further described herein. In one embodiment, the scheduler 200, may be implemented in a computer program (or “application”) embodied in a computer readable medium and including instructions usable by one or more processors of one or more computers of one or more systems. The computer program may include one or more software programs including program instructions in source code, object code, executable code or other formats; one or more firmware programs; or hardware description language (HDL) files; and any program related data. The data may include data structures, libraries, look-up tables, or data in any other suitable format. The program instructions may include program modules, routines, programs, objects, components, or the like. The computer program may be executed on one computer or on multiple computers in communication with one another.

Battery pack thermal preconditioning scheduler 200 may include a decision input block 201 and planning block 203. Generally, the decision input block 201 may include user inputs including settings, preferences, customizations, requests, and the like. In one embodiment, a user may manually request, at a manual settings module 211, battery pack thermal preconditioning immediately, in accordance with some possible time delay (e.g., in 30 minutes), in accordance with a single or repetitive time/date setting (e.g., 6 a.m. on Monday mornings), in accordance with a time/date interval (e.g., odd numbered days, every third day), or in accordance with other fixed schedule settings. Additionally or alternatively, a user may manually request battery pack thermal preconditioning to coincide with a user set minimum battery pack range. In such scenarios, the user simply provides a set-and-forget request at a manual settings module 211 that will invoke battery pack thermal preconditioning in accordance with the setting. Such manual settings may be received via the various vehicle-user interfaces 50-56 (FIG. 1) and provided to the manual settings module 211. For example, user settings may be provided via push buttons 52, visual display 50, a microphone 54, audio system 56 and voice recognition/dialogue manager, mobile devices 90, etc.

In another embodiment, an automated invocation of battery pack preconditioning may rely upon an event based module 213 of the decision input block 201. The event based module 213 may rely upon user preferences, for example between or among various user specific preferences. In accordance with one embodiment a user may set or select at least one of a limited number of available preferences at a preference module 212, such as charging time (i.e. minimizing time at charging station) and battery pack range (maximizing battery pack range). For example, a user may be uncertain regarding travel to a charging station and thus preferentially desires to maintain a higher battery pack charge in lieu of a shorter time spent at a charging station. In such a scenario, the user may prioritize or select battery pack range over charging time. A simple selection of one preference over another will thus prioritize the selected preference. Multiple preferences may be prioritized by the user through a numerical ranking or similar setting. One having ordinary skill in the art will understand that personal preferences may be one-dimensional, multi-dimensional, or subject to limits and conditions. User preferences at preference module 212 may be received via various vehicle-user interfaces and provided to the event based module 213. For example, user settings may be provided via push buttons 52, visual display 50, a microphone 54, audio system 56 and voice recognition/dialogue manager, mobile devices 90, etc. One exemplary system for managing user preferences is disclosed in commonly owned US Patent Publication 2016/0180236 A1 which is incorporated herein by reference. In accordance with an embodiment, event based module 213 may include a data collection module 215 to log vehicle usage information regarding, for example, charge site visitations, battery pack range, route information such as vehicle origin and destination, and temporal information such as time of day and day of week. In accordance with an embodiment, event based module 213 may further include a learning module 217 which may include a machine learning model for use in scheduling charging events given current vehicle location and temporal conditions (e.g., date and time). In one embodiment, the machine learning model of the learning module 217 may include a probabilistic model providing a probability of a charging event (charge event probability (PrC)) at a known charging station based on current vehicle location and temporal conditions (e.g., date and time). One skilled in the art will appreciate that the machine learning model of the learning module 217 may require an initial training period wherein the data collection module 215 and learning module 217 may collect statistically significant training datasets of vehicle usage information and converge the machine learning model solutions. Statistically significant training datasets of vehicle usage information may be defined in terms of time, drive cycles, charging cycles or other metrics. For example, frequent daily short trip vehicle usage with infrequent charging events may require several weeks of vehicle usage information logging before training datasets are sufficient. In contrast, frequent daily extended trip vehicle usage with one or more daily charging events may require a shorter period of vehicle usage information logging before training datasets are sufficient. Thereafter, the data collection module 215 may collect an additional dataset of vehicle usage information to validate the trained machine learning model of the learning module 217. In other embodiments, the learning module 217 may include a non-probabilistic model. In any case, the learning module 217 may include some type of machine learning model reliant upon a training dataset of vehicle usage information from the data collection module 215. Preferably, the data collection module 215 continues to log vehicle usage information and retains such information in updated datasets for periodic validation of the trained machine learning model of the learning module 217 and re-training as may be periodically system or user invoked. The machine learning model, once trained and validated, may be provided in the event based model 213 as an executable model 219.

In another embodiment, an automated invocation of battery pack preconditioning may rely upon a schedule based module 221 of the decision input block 201. Similar to the event based module 213, the schedule based module 221 also may rely upon user preferences, for example between or among various user specific preferences. As with the event based module 213, a user may select from a limited number of available preferences at a preference module 212, such as charging time (i.e. minimizing time at charging station) and battery pack range (maximizing battery pack range). For example, a user may be confident regarding travel to a charging station and thus preferentially desires a shorter time spent at a charging station over maintaining a higher battery pack charge. In such a scenario, the user may prioritize or select charging time over battery pack range. A simple selection of one preference over another will thus prioritize the selected preference. Multiple preferences may be prioritized by the user through a numerical ranking or similar setting. One having ordinary skill in the art will understand that personal preferences may be one-dimensional, multi-dimensional, or subject to limits and conditions. As with the event based module 213, user preferences at preference module 212 may be received via the various vehicle-user interfaces and provided to the schedule based module 221. In accordance with an embodiment, schedule based module 221 may include a data collection module 223 to log vehicle usage information regarding, for example, charge site visitations, battery pack range, route information such as vehicle origin and destination, and temporal information such as time of day and day of week. As with event based module 213, a learning module 225 may include a machine learning model for use in scheduling charging events given current vehicle location and temporal conditions (e.g., date and time). In one embodiment, the machine learning model of the learning module 225 may include a probabilistic model providing a probability of a charging event (charge event probability (PrC)) at a known charging station based on current vehicle location and temporal conditions (e.g., date and time). One skilled in the art will appreciate that the machine learning model of the learning module 225 may require an initial training period wherein the data collection module 223 and learning module 225 may collect statistically significant training datasets of vehicle usage information and converge the machine learning model solutions. In addition to current vehicle location and temporal conditions (e.g., date and time), a user provided schedule may provide additional input to the learning module 225 for use in training the machine learning model of the learning module 225. A scheduling module 229 may optionally collect a user provided schedule for provision to the schedule based module 221 to initialize or seed the learning module 225. Such user provided schedule may be received via the various vehicle-user interfaces 50-56 (FIG. 1) and provided to the scheduling module 229. For example, user settings may be provided via push buttons 52, visual display 50, a microphone 54, audio system 56 and voice recognition/dialogue manager, mobile devices 90, etc. In one embodiment, user schedules may be imported or synced from calendar applications on mobile device 90. As with the event based module 213, statistically significant training datasets of vehicle usage information may be defined in terms of time, drive cycles, charging cycles or other metrics. Thereafter, the data collection module 223 may collect an additional dataset of vehicle usage information to validate the trained machine learning model of the learning module 225. In other embodiments, the learning module 225 may include a non-probabilistic model. In any case, the learning module 225 may include some type of machine learning model reliant upon a training dataset of vehicle usage information from the data collection module 223. Preferably, the data collection module 223 continues to log vehicle usage information and user schedules, and retains such information in updated datasets for periodic validation of the trained machine learning model of the learning module 225 and re-training as may be periodically system or user invoked. The machine learning model, once trained and validated, may be provided in the schedule based module 221 as an executable model 227.

In one embodiment, all or some of the decision input block 201 of the battery pack thermal preconditioning scheduler 200 may be implemented remote from the vehicle 12. For example, the machine learning model of the learning module 217 and the machine learning model of the learning module 225 may be implemented remote from the vehicle 12. As well, the executable models 219 and 227 may be implemented remote from the vehicle. Training of machine learning models may be performed on computer 78 or server 82 assets provisioned to the vehicle 12. In one embodiment, vehicle usage information from the data collection module 215 and data collection module 223 may be uploaded and stored in database 84. As described herein, statistically significant training datasets of vehicle usage information are collected in a training phase of the learning module 217 and the machine learning model of the learning module 225. These datasets are preferably maintained in database 84 and accessed by computer 78 or server 82 which are configured to train the machine learning model of the learning module 217 and the machine learning model of the learning module 225. Similarly, as described herein, statistically significant validation datasets of vehicle usage information are collected in a validation phase of the learning module 217 and the machine learning model of the learning module 225. These datasets are also preferably maintained in database 84 and accessed by computer 78 or server 82 for validation of the trained machine learning model of the learning module 217 and the trained machine learning model of the learning module 225. Fully trained and validated models may be provisioned to the vehicle 12 as executable models 219 and 227 for implementation on one or more VMCs including BPCM 64. However, executable models 219 and 227 may also be implemented remotely. Subsequent to deployment of fully trained and validated models for implementation on vehicle 12 or remotely, ongoing logs of vehicle usage information may be uploaded and stored in database 84 for periodic validation of the executable models and re-training as may be periodically system or user invoked.

Each of the manual settings module 211, the event based module 213, and the schedule based module 221 may be independently enabled within the battery pack thermal preconditioning scheduler 200, or the vehicle original equipment manufacturer may limit offering of one or more of the modules in certain vehicles. Certain users may prefer manual control and thus may choose to disable or bypass the predictive intelligence features of the event based module 213 and the schedule based module 221 in favor of the manual setting module 211. Similarly, other users may prefer some level of predictive intelligence in battery pack thermal preconditioning yet lack a regular schedule of vehicle usage. Thus, such a user may enable the event based module 213 and bypass the manual settings module 211 and the schedule based module 221.

In one embodiment, the battery pack thermal preconditioning scheduler 200 may include a planning block 203 receiving from the decision input block 201 the manual request for thermal preconditioning from the manual settings module 211 or the respective outputs (e.g., charge event probability (PrC) and predicted charging destination) from the respective executable models 219 and 227 of the event based module 213 or the schedule based module 221. Manual requests may be indicated in terms of a reserved charge event probability (PrC) setting (e.g., PrC=1). Similarly, a charge event probability (PrC) setting PrC=0 may be reserved to indicate that the respective executable model 219, 227 is not yet ready or operational (e.g., is not populated with a fully trained and validated model). Otherwise, charge event probability (PrC) may be provided in accordance with respective executable model 219, 227 outputs of probabilities between 0 and 1. Planning block 203 includes a routine 251 monitoring the decision input block 201 and other relevant inputs (e.g., time, map data including charging station locations, current vehicle location, destinations or routes, battery pack temperature, SOC, etc.) at step 253. In one embodiment, the routine 251 evaluates at step 255 the probability (PrC) of a charge event occurring at a known recharging location within a predetermined time frame. The predetermined timeframe may, for example, simply be a value greater than some minimum time related to vehicle specific design parameters, may be related to current battery pack temperature, or a combination of such considerations and others. In one embodiment, when the charge event probability (PrC) does not exceed some predetermined threshold of certainty (e.g., PrC≤0.5) <254>, then the routine 251 may continue to monitor at step 253 as described above. Additionally, where the PrC may indicate the respective executable model 219, 227 is not yet ready or operational, the user may be notified and provided opportunity to manually request battery pack thermal preconditioning (e.g., through manual settings module 211). Otherwise, when the charge event probability (PrC) exceeds the threshold of certainty (e.g., PrC>0.5) <256>, then the routine 251 at step 257 may determine a preferred charging station based, for example, upon current vehicle location and temporal conditions (e.g., date and time) and the respective executable model 219, 227. Alternatively, the routine 251 at step 257 may determine a preferred charging station as the closest charging station on or off a route based on additional considerations such as current battery range or minimum battery pack range user preference settings for example. The routine 251 at step 261 may determine a duration for thermal conditioning based on the vehicle current location, the preferred charging station, and other factors such as current battery pack temperature. This step may also calculate a predicted SOC reduction and associated reduction in battery pack range and provide the information to other vehicle systems that may benefit from such anticipated changes.

In one embodiment, the routine 251 at step 263 evaluates the duration for thermal conditioning determined at step 261. When the duration is null <262>, indicating no thermal conditioning duration required, the routine 251 is exited at step 265. Otherwise, the routine 251 may continue <264> to steps related to user intervention and approvals as may be selectively enabled by the user in customization settings of the vehicle (e.g., at preference module 212). At step 267, for example, a user approval setting may be checked. When no further approvals are required <268>, the routine 251 continues to step 273. When further approvals are required <266>, the routine 251 continues to step 269 where required approval steps may provide the user with additional decision information such as the effect that thermal preconditioning will have upon battery pack range. Such information may be provided, for example, via push buttons 52, visual display 50, audio system 56, mobile devices 90, etc. Next at step 271 a request for approval is made of the user, for example via push buttons 52, visual display 50, a microphone 54, audio system 56 and voice recognition/dialogue manager, mobile devices 90, etc. Approval requests may additionally request schedule confirmations or changes, delays, ignoring or cancelations for more accurate scheduling of the thermal preconditioning. Without approval or with schedule changes, delays or cancelations <272>, the routine may return to monitor at step 253 as described above for continued routine 253 execution including updated schedules, delays and cancelations. With approval <274>, or when no approval was required at step 267, the thermal preconditioning of the battery pack is performed at step 273 at an appropriate time in accordance with the manual requests, event based model 213 and schedule based model 221 based user settings, preferences and schedule, determined duration, current vehicle location, temporal condition, and predicted charging destination such that the vehicle arrives at the charging station in a thermally preconditioned state. Step 273 may command the TMS 66 directly or through the BPCM to control the battery pack temperature to the predetermined range of temperature for a battery recharge event. The TMS 66 may then heat and/or cool the battery pack 62 as required in accordance with the determined duration for thermal conditioning.

Step 275 may provide relevant system information when the thermal preconditioning of the battery pack is carried out. For example, similar to the provision at step 261 of a predicted SOC reduction and associated reduction in battery pack range to other vehicle systems that may benefit from such anticipated changes, step 275 may provide such information to affected vehicle systems. Additionally, information benefitting the event based model and the schedule based model related to the current thermal preconditioning of the battery pack may be provided, for example through the data collection module 215 and data collection module 223. Routine 251 is exited at step 277.

Unless explicitly described as being “direct,” when a relationship between first and second elements is described in the above disclosure, that relationship may be a direct relationship where no other intervening elements are present between the first and second elements, but may also be an indirect relationship where one or more intervening elements are present (either spatially or functionally) between the first and second elements.

It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method for preconditioning a battery pack in a vehicle, comprising:
executing a machine learning model providing a probability of a charging event occurring with respect to time based upon a current vehicle location and temporal information; and
in response to the probability of the charging event within a predetermined timeframe exceeding a predetermined threshold:
determining a preferred charging station;
determining a duration for a thermal conditioning event; and
controlling a thermal management system to control the battery pack to a predetermined temperature range for the duration.

2. The method of claim 1, further comprising training the machine learning model with a training dataset comprising vehicle usage information and temporal information.

3. The method of claim 2, wherein the vehicle usage information comprises charge site visitations, battery pack range, vehicle origin and vehicle destination.

4. The method of claim 2, wherein the training dataset further comprises at least one user preference.

5. The method of claim 4, wherein the at least one user preference comprises at least one of charging time and battery pack range.

6. The method of claim 1, wherein executing the machine learning model occurs off the vehicle.

7. The method of claim 2, wherein training the machine learning model occurs off the vehicle.

8. The method of claim 1, wherein controlling the thermal management system comprises heating the battery pack.

9. The method of claim 1, wherein controlling the thermal management system comprises cooling the battery pack.

10. The method of claim 2, wherein the training dataset further comprises a user schedule.

11. A system for preconditioning a battery pack in a vehicle, comprising:
a thermal management system comprising a battery pack heater powered by the battery pack; and
a processor and a memory containing a computer program when executed by the processor causes a machine learning model to:
predict a charging event occurring with respect to time based upon a current vehicle location and temporal information;
determine a preferred charging station;
determine a duration for a thermal conditioning event; and
control the thermal management system to control the battery pack to a predetermined temperature range for the duration.

12. The system for preconditioning a battery pack in a vehicle of claim 11, wherein the computer program comprises a machine learning model.

13. The system for preconditioning a battery pack in a vehicle of claim 12, wherein the machine learning model comprises a probability model and wherein predicting the charging event occurring with respect to time based upon a current vehicle location and temporal information comprises providing a probability of the charging event occurring within a predetermined time frame based upon a current vehicle location and temporal information.

14. The system for preconditioning a battery pack in a vehicle of claim 12, wherein the machine learning model is trained off the vehicle.

15. The system for preconditioning a battery pack in a vehicle of claim 13, wherein the probability model is trained off the vehicle with a training dataset comprising vehicle usage information and temporal information.

16. The system of claim 15, wherein the vehicle usage information comprises charge site visitations, battery pack range, vehicle origin and vehicle destination.

17. The system of claim 16, wherein the training dataset further comprises at least one user preference.

18. The system of claim 17, wherein the at least one user preference comprises at least one of charging time and battery pack range.

19. A battery electric vehicle, comprising:
a controller;
a rechargeable battery pack; and
a battery pack heater powered by the rechargeable battery pack;
the controller configured to:
receive at least one user preference, vehicle usage information including a current vehicle location and temporal information;
provide a probability of a charging event occurring within a predetermined time frame based upon the current vehicle location and temporal information;
in response to the probability of the charging event exceeding a predetermined threshold:
determining a preferred charging station for the charging event;
determining a duration for powering the battery pack heater by the rechargeable battery pack sufficient to heat the rechargeable battery pack to a predetermined range of temperature within the predetermined time frame; and
powering the battery pack heater with the rechargeable battery pack for the duration.

20. The battery electric vehicle of claim 19, wherein:
the controller is further configured to receive a user schedule; and
the probability of the charging event occurring within a predetermined time frame is further based upon the user schedule.
